(19) United States
(12) Patent Application Publication
(10) Pub. No.: US 2015/0076807 A1
(43) Pub. Date: Mar. 19, 2015

(54) ANTI-FORGERY LABEL USING RANDOM PROTRUDING ELEMENTS AND METHOD FOR MANUFATURING THE SAME

(71) Applicants: Fu-Pi Pao, Taipei City (TW); San-Yuan Wu, Taipei City (TW); Kuan-Ying Pao, Taipei City (TW)

(72) Inventors: Fu-Pi Pao, Taipei City (TW); San-Yuan Wu, Taipei City (TW); Kuan-Ying Pao, Taipei City (TW)

(73) Assignee: SENSE DIGITAL CO., LTD., Taipei City (TW)

(21) Appl. No.: 14/466,910

(22) Filed: Aug. 22, 2014

(30) Foreign Application Priority Data
Sep. 14, 2013 (TW) 102133306

(51) Int. Cl. G09F 3/02

(52) U.S. Cl. CPC G09F 3/02; G09F 2003/0208; G09F 2003/0257; G09F 2003/0202
USPC 283/81; 29/458

(57) ABSTRACT

A method for manufacturing an anti-forgery label using random protruding elements. A substrate is provided with an adhesive layer on one side and a printed layer on the other side thereof. A plurality of protruding elements is randomly disposed on the printed layer. A transparent overcoat layer is tightly bonded over the protruding elements and the printed layer to enclose and secure the protruding elements and form effective protection for the printed layer, such that the protruding elements offer a tactile sensation as well as visual identification of the distribution pattern of the protruding elements. In addition, information is provided on at least one surface of the printed layer or the overcoat layer, which, upon analysis, allows a user to connect to a default data storage device in order to obtain anti-forgery information of a product.

### BACKGROUND OF THE INVENTION

1. Field of the Invention

The invention relates to an anti-forgery label using random protruding elements and method for manufacturing the same, and more particularly, to an anti-forgery label using random protruding elements and method for manufacturing the same that provides random protruding elements on the label to simultaneously offer a tactile sensation and visual identification so as to provide a better anti-forgery effect.

2. Description of the Prior Art

Conventional carrier structures (labels) with anti-forgery identification features, for example, as seen in CN Patent Application No. 97126167.9 titled “NATURAL ANTI-FORGERY METHOD”, are made into fixed-sized (square, circular or other shapes) sheets with natural materials such as wood or stone. Each of these inherently characteristic sheets is individually assigned with a random number using a computer, and then the number is printed on the sheet. Then, the textures and patterns of the sheets are scanned and filed for future inquiries.

This type of identification technique is based on the texture of the natural materials (e.g. wood or stone). However, under the current manufacturing environment with advanced photographic reproduction techniques, the fact that this type of identification method relies on simple visual identification of the features may not achieve the anticipated anti-forgery effect.

CN Patent Application No. 99801139.8 titled “STRUCTURAL TEXTURE ANTI-FORGERY METHOD” uses materials having unambiguous and random structural textures as anti-forgery identification objects that utilize the random structural textures as anti-forgery information. The anti-forgery information are scanned or recorded with a scanning device and stored in a computer identification database. Consumers may obtain information about the structural textures via communication tools such as phones, faxes or networked computers to verify the genuineness of the texture information of the products.

The abovementioned random structural texture refers to a random texture integrated into an artificial carrier structure. For example, filaments are added into paper pulp in which the distribution of the filaments is used as anti-forgery information. However, this type of anti-forgery labels can be counterfeited by providing similar visual effects of the features using the current printing (including stamping) techniques, such that an inquirer may find it difficult to distinguish between a printed counterfeit and filaments unless the filaments are stripped off the carrier. Doing so requires time and effort and may easily damage the anti-forgery label.

Moreover, in CN Patent Application No. 200910135421.4 titled “ANTI-FORGERY METHOD OF STRUCTURAL TEXTURE”, an anti-forgery mark is numbered and provided with a random texture given by angle-dependent color-shifting fibers. The feature of this random texture and the number are stored in a database for consumers to verify the genuineness of the random texture feature. Since it is impossible to counterfeit the angle-dependent color-shifting fibers by printing, the anti-forgery effectiveness of this type of texture is largely improved.

However, the anti-forgery method just mentioned can still be counterfeited to some extent with the current photocopying printing techniques, causing visual confusion to an inquirer, such that the inquirer may not immediately ascertain if the label is a printed counterfeit. This is a practical shortcoming.

In view of the shortcomings in the conventional planar anti-forgery mechanisms using random textures, the present invention is proposed to provide improvements that address these shortcomings.

### SUMMARY OF THE INVENTION

One main objective of the present invention is to provide an anti-forgery label using random protruding elements that offers multiple anti-forgery mechanisms such as a tactile sensation to users through randomly arranged protruding element(s) on the label and visual identification of the distribution of the protruding element(s) upon inquiry to overcome the shortcoming of causing visual confusion to the users by forging traditional planar anti-forgery mechanisms with photographic reproduction techniques.

Another objective of the present invention is to provide an anti-forgery label using random protruding elements. The protruding elements on the surface of the label are formed by adhering protruding elements of various default shapes on the surface of the label. The protruding elements can be made to have fluorescent, infrared, and/or magnetic features, thereby increasing the difficulty of forgery.

Still another objective of the present invention is to provide a method for manufacturing an anti-forgery label using random protruding elements that allows protruding elements to be easily, effectively and securely bonded onto the surface of the label in a random manner to form protruding elements that offer a tactile sensation, thus enhancing the overall economic benefits.

In order to achieve the above and other objectives and efficacies, the technical means employed by the present invention may include: an anti-forgery label using random protruding elements, which may include at least: a substrate provided with an adhesive layer on one side and a printed layer on the other side thereof; a plurality of protruding elements randomly disposed on the printed layer; a transparent overcoat layer covering the protruding elements and the printed layer to form effective protection; and a bonding layer provided between the overcoat layer and the printed layer to bond the overcoat layer onto the printed layer and enclose the protruding elements in conformity such that they provide a tactile sensation for identification.

In the above structure, the bonding layer is provided on a side of the overcoat layer closer to the printed layer so as to adhere the overcoat layer onto the printed layer.

In the above structure, the bonding layer is provided on a side of the printed layer closer to the overcoat layer so as to bond the printed layer and the overcoat layer together.

In the above structure, the printed layer includes a barcode area, which, after analysis, provides information for connecting to a default data storage device so that a user is able to obtain anti-forgery information for authenticating a product.

In the above structure, the overcoat layer includes a printed barcode area, which, after analysis, provides information for connecting to a default data storage device so that a user is able to obtain anti-forgery information for authenticating a product.

In the above structure, the printed barcode area is provided on a side of the overcoat layer closer to the printed layer.

In the above structure, the printed barcode area is provided on a side of the overcoat layer away from the printed layer.

In the above structure, the protruding elements are in the form of at least one of the following protruding shapes of round bumps, rods, and cones.

In the above structure, the protruding elements are structures of light-emitting and color-shifting features under a certain lighting condition at a specific wavelength.

In the above structure, the printed area includes a graphic area, which includes one or more images, texts or symbols for describing or advertising a product or serving as anti-forgery information for the product.

A method for manufacturing an anti-forgery label using random protruding elements, which may include: a step of “providing an adhesive layer on one side of a substrate and printing a printed layer with one or more required images and/or texts on the other side thereof”, wherein the substrate is provided with the adhesive layer on one side and the printed layer on the other side, the printed layer at least includes information that, after analysis, allows a user to connect to a default data storage device to obtain anti-forgery information for authenticating a product; a step of “randomly disposing a plurality of protruding elements on the printed layer”, wherein the plurality of protruding elements are directly disposed on the printed layer in a random manner; and a step of “covering the plurality of protruding elements and the printed layer with a transparent overcoat layer, wherein the overcoat layer is adhered to the printed layer to secure and enclose the plurality of protruding elements”, and wherein the protruding elements and the printed layer are tightly covered with the transparent overcoat layer, the overcoat layer is bonded onto the printed layer to enclose and secure the protruding elements.

The accomplishment of this and other objectives of the invention will become apparent from the following description and its accompanying drawings of which:

### BRIEF DESCRIPTION OF THE DRAWINGS

FIG. 1 is a flowchart illustrating a manufacturing method in accordance with the present invention.

FIG. 2 is a planar structure diagram depicting a first embodiment of a label in accordance with the present invention.

FIG. 3 is a planar structure diagram depicting a second embodiment of a label in accordance with the present invention.

FIG. 4 is a planar structure diagram depicting a third embodiment of a label in accordance with the present invention.

FIG. 5 is a planar structure diagram depicting a fourth embodiment of a label in accordance with the present invention.

### DETAILED DESCRIPTION OF THE PREFERRED EMBODIMENT

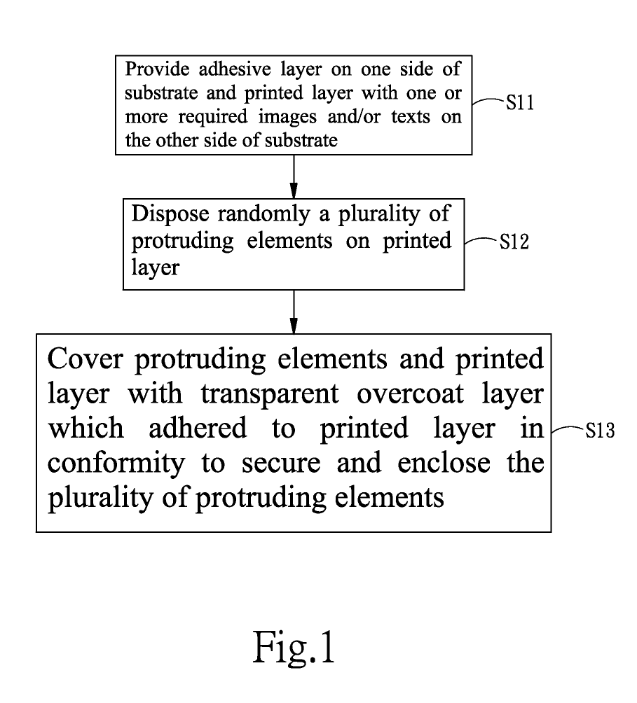

With reference to FIG. 1, a method of the present invention includes: (S11) providing an adhesive layer on one side of a substrate and printing a printed layer with one or more required images and/or texts on the other side thereof; (S12) randomly disposing a plurality of protruding elements on the printed layer; and (S13) covering the plurality of protruding elements and the printed layer with a transparent overcoat layer, wherein the overcoat layer is adhered to the printed layer to secure and enclose the plurality of protruding elements.

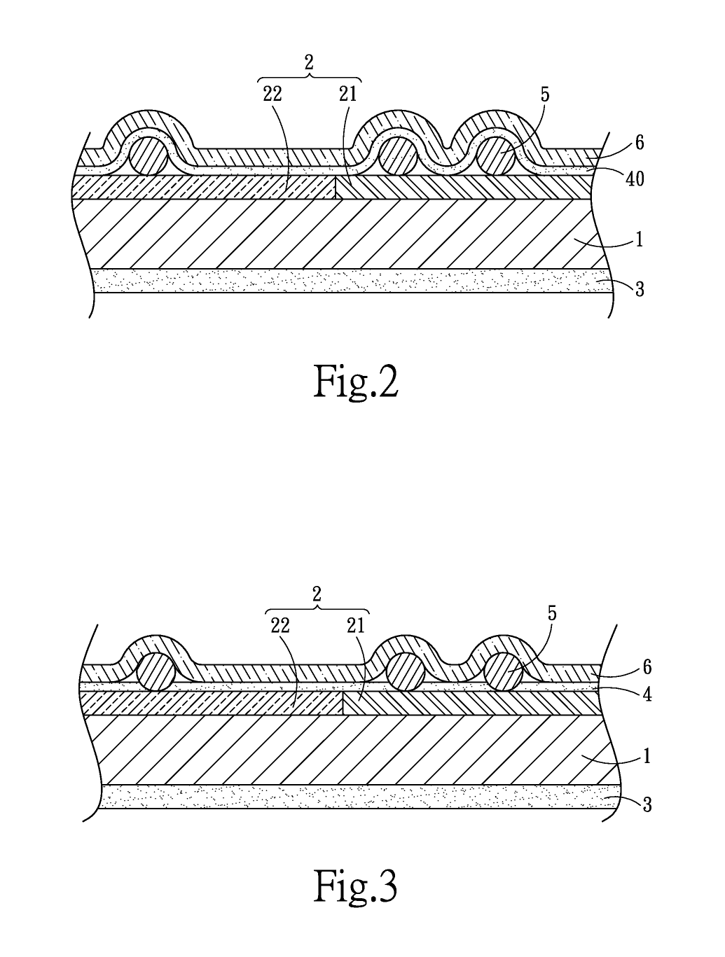

The abovementioned steps may have various implementation aspects in actual practice, and are further illustrated with reference to FIGS. 2 to 5 below.

First, in step S11 of “providing an adhesive layer on one side of a substrate and printing a printed layer with required picture and/or texts on the other side thereof”, a side of a substrate 1 is provided with an adhesive layer 3. This adhesive layer may be an adhesive provided in advance on a side of the substrate 1, and a release paper can be provided on the adhesive depending on the needs. A printed layer 2 with required picture and/or texts are formed by printing on the other side (i.e. on the side away from the adhesive layer 3) of the substrate 1.

In step S12 of “randomly disposing a plurality of protruding elements on the printed layer”, a plurality of protruding elements 5 is randomly arranged on the printed layer 2. In actual practice, the protruding elements 5 may be in the form of round bumps, rods, cones or any other protruding shapes that can be clearly felt through touching so that a consumer may perform a preliminary elimination of photographic counterfeits through the sense of touch. Furthermore, the protruding elements 5 also exhibit an anti-forgery material characteristic such as a color- or light-shifting feature (e.g. a color-changing fluorescent response under fluorescent conditions at a specific wavelength) or magnetic sensitive or temperature-dependent color shifting feature, thereby providing more security.

In step S13 of “covering the plurality of protruding elements and the printed layer with a transparent overcoat layer, wherein the overcoat layer is adhered to the printed layer to secure and enclose the plurality of protruding elements”, a transparent overcoat layer 6 is adhered in conformity on the protruding elements 5 and the printed layer 2 to secure and enclose the various protruding elements 5 and provide effective protection for the printed layer 2. In addition, the protruding elements 5 on the surface of the printed layer 2 provide anti-forgery features of a tactile sensation as well as a visual identification of the distribution locations of the elements.

As shown in FIG. 2, in the structures of a first embodiment of the present invention, in addition to the structures such as the substrate 1, the adhesive layer 3, the protruding elements 5 and the overcoat layer 6 mentioned above, the printed layer 2 at least includes a graphic area 21 and a barcode area 22. The graphic area 21 may be one or more images, texts or symbols for describing or advertising the product or serving as an additional planar anti-forgery identification, allowing a consumer to have an initial understanding of the product. The barcode area 22 can be any type of barcode structures such as a QR code, a MATRIX code and the like. Upon analyzing the barcode, information for connecting to a default data storage device can be provided so that the consumer is able to obtain anti-forgery information for authenticating the product.

An additional bonding layer 40 is provided in advance on the side of the overcoat layer 6 closer to the printed layer 2, so as to combine the overcoat layer 6 and the printed layer 2 through the bonding layer 40, and to enclose and secure the various protruding elements 5.

As can be seen in FIG. 3, the structures of a second embodiment of the present invention include structures (the substrate 1, the printed layer 2, the adhesive layer 3, the protruding elements 5 and the overcoat layer 6) that are the same as the first embodiment of the present invention, the difference lies in that an bonding layer 4 is provided in advance on the side of the printed layer 2 closer to the overcoat layer 6. The bonding layer 4 not only adheres and secures the protruding elements 5 directly, but also adheres to the overcoat layer 6, so that the overcoat layer 6 can be combined on the outer surface of the printed layer 2 and the protruding elements 5.

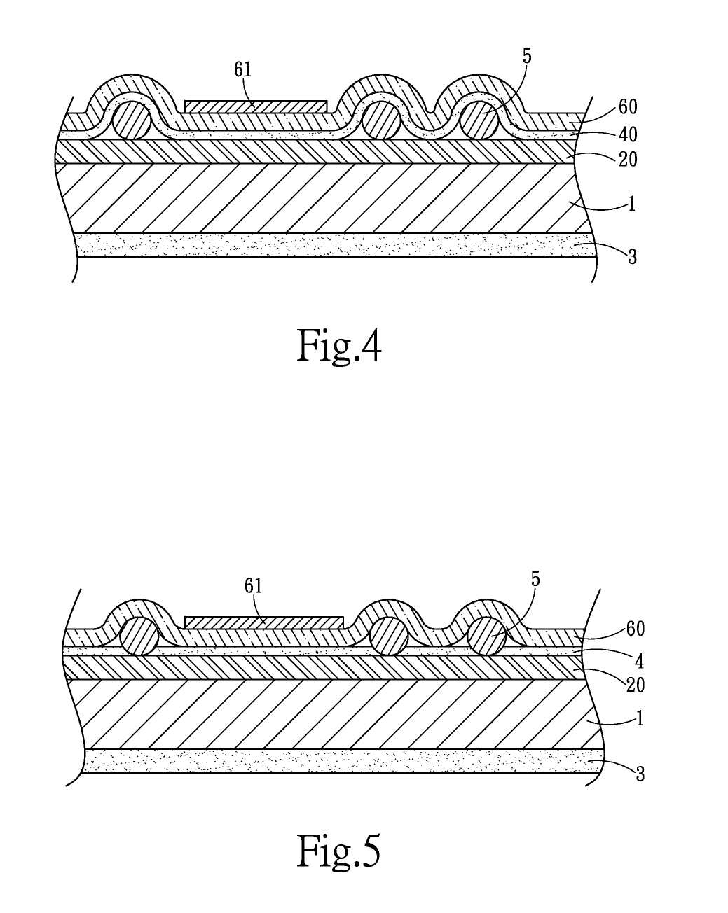

As can be seen in FIG. 4, the structures of a third embodiment of the present invention include: a printed layer 20 and a overcoat layer 60 as well as structures (the substrate 1, the adhesive layer 3, bonding layer 40 and the protruding elements 5) that are the same as the first embodiment of the present invention, wherein the bonding layer 40 is provided in advance on the side of the overcoat layer 60 closer to the substrate 1. The printed layer 20 is disposed on the side of the substrate 1 closer to the overcoat layer 60, and the printed layer 2 contains only contents similar to those described with respect to the graphic area 21 before (i.e. one or more images, texts or symbols for describing the product or serving as an additional planar anti-forgery identification). Moreover, a printed barcode area 61 is provided on a side of the overcoat layer 60. This printed barcode area 61 has similar structural features of the barcode area 22 before (information for connecting to a default data storage device is provided upon analyzing the barcode).

In the structures of this embodiment, apart from disposing the printed barcode area 61 on the side (outer side) of the overcoat layer 60 away from the substrate 1, it can also be disposed on the side (inner side) of the overcoat layer 60 closer to the substrate 1, achieving the same display effect.

As can be seen in FIG. 5, the structures of a fourth embodiment of the present invention include: a printed layer 20 and a overcoat layer 60 as well as structures (the substrate 1, the adhesive layer 3, the bonding layer 4 and the protruding elements 5) that are the same as the second embodiment of the present invention, wherein the bonding layer 4 is provided in advance on the side of the substrate 1 closer to the overcoat layer 60. The bonding layer 4 not only adheres and secures the protruding elements 5 directly, but also adheres to the overcoat layer 60, so that the overcoat layer 60 can be combined on the outer surface of the printed layer 20 and the protruding elements 5. The printed layer 20 is provided on the side of the substrate 1 closer to the overcoat layer 60, and the printed layer 20 contains only contents similar to those described with respect to the graphic area 21 before (i.e. a picture, texts or symbols for describing the product or serving as an additional planar anti-forgery identification). Moreover, a printed barcode area 61 is provided on a side of the overcoat layer 60. This printed barcode area 61 has similar structural features of the barcode area 22 before (information for connecting to a default data storage device is provided upon analyzing the barcode).

In the structures of this embodiment, apart from disposing the printed barcode area 61 on the side (outer side) of the overcoat layer 60 away from the substrate 1, it can also be disposed on the side (inner side) of the overcoat layer 60 closer to the substrate 1, achieving the same display effect.

In summary, the shortcoming of causing confusions to viewers by producing visually similar labels using photographic reproduction techniques in the prior art is alleviated with the anti-forgery label using random protruding elements and the method for manufacturing the same of the present invention by simultaneously providing a tactile sensation as well as visual identification to users with the use of random protruding elements to increase the anti-forgery effect. In view of this, the present invention is submitted to be novel and non-obvious and a patent application is hereby filed in accordance with the patent law. It should be noted that the descriptions given above are merely descriptions of preferred embodiments of the present invention, various changes, modifications, variations or equivalents can be made to the invention without departing from the scope or spirit of the invention. It is intended that all such changes, modifications and variations fall within the scope of the following appended claims and their equivalents.

What is claimed is:

1. An anti-forgery label using random protruding elements, comprising:
a substrate provided with an adhesive layer on one side and a printed layer on the other side thereof;
a plurality of protruding elements randomly disposed on the printed layer;
a transparent overcoat layer covering the protruding elements and the printed layer to form effective protection; and
a bonding layer provided between the overcoat layer and the printed layer to bond the overcoat layer onto the printed layer and enclose the protruding elements in conformity such that they provide a tactile sensation for identification.

2. The anti-forgery label using random protruding elements as claimed in claim 1, wherein the bonding layer is provided on a side of the overcoat layer closer to the printed layer so as to adhere the overcoat layer onto the printed layer.

3. The anti-forgery label using random protruding elements as claimed in claim 1, wherein the bonding layer is provided on a side of the printed layer closer to the overcoat layer so as to bond the printed layer and the overcoat layer together.

4. The anti-forgery label using random protruding elements as claimed in claim 1, wherein the printed layer includes a barcode area, which, after analysis, provides information for connecting to a default data storage device so that a user is able to obtain anti-forgery information for authenticating a product.

5. The anti-forgery label using random solid objects as claimed in claim 1, wherein the overcoat layer includes a printed barcode area, which, after analysis, provides information for connecting to a default data storage device so that a user is able to obtain anti-forgery information for authenticating a product.

6. The anti-forgery label using random solid objects as claimed in claim 5, wherein the printed barcode area is provided on a side of the overcoat layer closer to the printed layer.

7. The anti-forgery label using random protruding elements as claimed in claim 5, wherein the printed barcode area is provided on a side of the overcoat layer closer to or away from the printed layer.

8. The anti-forgery label using random protruding elements as claimed in claim 1, wherein the protruding elements are in the form of at least one of the following protruding shapes of round bumps, rods, and cones.

9. The anti-forgery label using random protruding elements as claimed in claim 1, wherein the protruding elements are structures of light-emitting and color-shifting features under a certain lighting condition at a specific wavelength.

10. The anti-forgery label using random protruding elements as claimed in claim 1, wherein the printed area includes a graphic area, which includes one or more images, texts or symbols for describing or advertising a product or serving as anti-forgery information for the product.

11. A method for manufacturing an anti-forgery label using random protruding elements, comprising:
a step of “providing an adhesive layer on one side of a substrate and printing a printed layer with one or more required images and/or texts on the other side thereof”, wherein the substrate is provided with the adhesive layer on one side and the printed layer on the other side, the printed layer at least includes information that, after analysis, allows a user to connect to a default data storage device to obtain anti-forgery information for authenticating a product;
a step of “randomly disposing a plurality of protruding elements on the printed layer”, wherein the plurality of protruding elements are directly disposed on the printed layer in a random manner; and
a step of “covering the plurality of protruding elements and the printed layer with a transparent overcoat layer, wherein the overcoat layer is adhered to the printed layer to secure and enclose the plurality of protruding elements”, and wherein the protruding elements and the printed layer are tightly covered with the transparent overcoat layer, the overcoat layer is bonded onto the printed layer to enclose and secure the protruding elements.
